(19) United States
(12) Patent Application Publication
(10) Pub. No.: US 2010/0136225 A1
(43) Pub. Date: Jun. 3, 2010

(54) GROUP IVA SMALL PARTICLE COMPOSITIONS AND RELATED METHODS

(75) Inventors: Archit Lal, Ithaca, NY (US); Robert J. Dobbs, Newfield, NY (US)

Correspondence Address: WOLF GREENFIELD & SACKS, P.C., 600 ATLANTIC AVENUE, BOSTON, MA, 02210-2206, US

(73) Assignee: Primet Precision Materials, Inc., Ithaca, NY (US)

(21) Appl. No.: 12/605,050

(22) Filed: Oct. 23, 2009

Related U.S. Application Data
(60) Provisional application No. 61/108,336, filed on Oct. 24, 2008.

(51) Int. Cl. H01B 1/04; B05D 1/18; B05D 3/12; B05D 5/12; B32B 5/16

(52) U.S. Cl. 427/122; 427/430.1; 427/240; 428/402; 252/502

(57) ABSTRACT

Group IVA (e.g., silicon, germanium) small particle compositions and related methods are described. In some embodiments, the small particle compositions and related methods are used to form a layer on a substrate.

### RELATED APPLICATIONS

This application claims priority to U.S. Provisional Application No. 61/108,336, filed Oct. 24, 2008, which is incorporated herein by reference in its entirety.

### FIELD OF INVENTION

This invention relates generally to group IVA (e.g., silicon, germanium) small particle compositions and related methods. In some embodiments, the small particle to compositions and related methods are used to form a layer on a substrate.

### BACKGROUND OF INVENTION

Group IVA elements include silicon and germanium. Such elements and related compositions may be used, for example, in electrochemical cells such as batteries. They may be processed, for example, to form powders that are used to form electrodes (e.g., anode, cathode) of the cell.

Milling processes typically use grinding media to crush, or beat, a product material to smaller dimensions. For example, the product material may be provided in the form of a powder having relatively large particles and the milling process may be used to reduce the size of the particles.

Grinding media may have a variety of sizes and shapes. In a typical milling process, the grinding media are used in a device known as a mill (e.g., ball mill, rod mill, attritor mill, stirred media mill, pebble mill). Mills typically operate by distributing product material around the grinding media and rotating to cause collisions between grinding media that fracture product material particles into smaller dimensions to produce a milled particle composition.

### SUMMARY OF INVENTION

Group IVA (e.g., silicon, germanium) small particle compositions and related methods are provided.

In one aspect, a method is provided. The method comprises milling a feed material to form particles comprising a group IVA element and having an average particle size of less than 250 nm. The method further comprises contacting a substrate with a mixture of the particles and a liquid to form a layer comprising the group IVA element on the substrate.

In another aspect, a method is provided. The method comprises milling a feed material to form particles comprising a group IVA element. The method further comprises forming a carbon coating on the particles having a thickness of less than 50 nm.

In another aspect, a method is provided. The method comprises providing a mixture of particles comprising the group IVA element and a liquid. The method further comprises contacting a substrate with the mixture to form a layer on the substrate, the to layer comprising greater than 50% by weight of the group IVA element.

In another aspect, a particle composition is provided. The particle composition comprises particles comprising a group IVA element and having an average particle size of less than 100 nm, wherein the particle composition is spin-coatable.

In another aspect, a particle composition is provided. The particle composition comprises particles comprising a group IVA element and having an average particle size of less than 100 nm, the particles having a carbon coating.

In another aspect, an article is provided. The article comprises a substrate and a coating formed from the particle compositions described above.

In another aspect, an article is provided. The article comprises a substrate and a coating formed from the particle composition described above.

Other aspects, embodiments and features of the invention will become apparent from the following detailed description when considered in conjunction with the accompanying drawings. The accompanying figures are schematic and are not intended to be drawn to scale. For purposes of clarity, not every component is labeled in every figure, nor is every component of each embodiment of the invention shown where illustration is not necessary to allow those of ordinary skill in the art to understand the invention. All patent applications and patents incorporated herein by reference are incorporated by reference in their entirety. In case of conflict, the present specification, including definitions, will control.

### BRIEF DESCRIPTION OF DRAWINGS

FIG. 1 illustrates a schematic electrochemical cell including an electrode formed from small particle compositions, according to an embodiment of the present invention.

FIG. 2 illustrates a battery structure including an electrode formed from small particle compositions, according to an embodiment of the present invention.

FIGS. 3A-3D are copies of SEM images of the particles described in Example 1.

FIG. 4 is a copy of a photograph depicting the dip-coated substrate described in Example 2.

FIG. 5 is a copy of a photograph exemplifying the spin-coated substrate described in Example 3.

FIGS. 6A-6D are copies of SEM images of the particles described in Example 4.

FIGS. 7A-7D are copies of SEM images of the particles described in Example 5.

FIGS. 8A-8D are copies of SEM images of the particles described in Example 5.

FIGS. 9A-9D are copies of SEM images of the particles described in Example 6.

FIGS. 10A-10D are copies of SEM images of the particles described in Example 7.

FIGS. 11A and 11B are copies of STEM images of the particles described in Example 9.

### DETAILED DESCRIPTION

This invention relates generally to group IVA (e.g., silicon, germanium) small particle compositions and related methods. The particles may be formed, for example, in a milling process. In some embodiments, the particles include a conductive coating such as carbon. The small particle compositions can be used to coat substrates using a variety of techniques, such as spin-coating, dip-coating, and cast-coating. The resulting coating layers may have improved properties such as increased stability during use and higher stress absorption. The coatings may be particularly useful in battery applications, for example, as coatings on electrodes. Other applications include conductive inks which are used, for example, in electronics.

As used herein, a “group IVA” composition is a composition that comprises a group IVA element. The group IVA element may be in elemental form or in the form of a compound that includes a group IVA element. Examples of suitable group IVA elements are silicon and germanium. Other suitable group IVA elements are carbon (e.g., in graphite form), tin and lead. In some cases, the particle compositions are formed of elemental silicon particles or elemental germanium particles. In some cases, the particles are formed of a silicon compositions (i.e., compositions that comprise silicon and may comprise one or more additional elements); in some cases, the particles are formed of a germanium compositions (i.e., compositions that comprise germanium and may comprise one or more additional elements).

In some embodiments, the group IVA composition may be a mixture, an alloy, and/or an intermetallic compound. Suitable group IVA compositions can include compositions formed from magnesium, copper and silicon. For example, in some embodiments, the particles may be formed of Mg₆Cu₁₆Si₇. In some embodiments, the particles may be formed of M₆Ni₁₆Si₇, where M=Mg, Sc, Ti, Nb, or Ta. In some embodiments, the composition may be AlSi₁₇CuNiMg and corresponding compositions comprised of Cr, Co, Mo, W, and/or Ti. Suitable compositions also include, for example, Si/Ge, Si/C, Ge/C, Si/Ge, Si/Sn, Si/Sn/C, Si/Cu/Co/Sn. These compositions may be in the form of mixtures, alloys or intermetallic compounds. In some cases, the group IVA composition may be a mixture of particles having different compositions. For example, the group IVA composition may have a mixture of Si and Ge particles, or any of the other combinations described above. Such compositions may be used to form composite structures.

It should be understood that the group IVA particle compositions may also include suitable dopants. The dopants may be n-type (e.g. N, P, As, Sb, Bi) or p-type (e.g. B, Al, Ga, In, Ti). Suitable dopants also include, for example, W and/or Zr. The dopants may be provided to enhance certain properties such as electrical conductivity and/or mobility of atoms such as Li.

Compounds may also be incorporated into the particles. For example, particles may be exposed to a fluorine precursor and then fired such that the fluorine is distributed in the particles or in agglomerates of the particles.

As noted above, in some embodiments, the particles may be coated. The coating may be used to enhance one or more properties of the particle compositions. For example, the coating may improve the performance of the particles in an electrode (e.g., of an electrochemical cell). The coated particles may exhibit improved conductivity when compared to uncoated particles.

In general, the coating material may be any suitable material capable of coating the surface of a particle. In some cases, it is preferable that the coating material is an electrically conductive material. In some embodiments, the coating may comprise carbon. Carbon coatings may be particularly preferred when the particles are silicon. For example, the coating material may be a carbon-containing material such as graphite (e.g., superior graphite), carbon nanotubes, and acetylene black. The carbon coating may include carbon having an sp2 configuration. The structure of the carbon coating can be evaluated using techniques known in the art, such as Raman spectroscopy. In some embodiments, the coating may be a conductive metal (e.g., cobalt, nickel). It should be understood that other coating compositions are also possible.

The coating may be in the form of a layer, in some embodiments. In other embodiments, the coating may take other forms such as a nanostructure (e.g., nanotube or nanorod) that extends from a surface of the particle. In these embodiments, the particles may function as catalysts for the growth of a structure such as a nanostructure. For instance, silicon particles may function as growth catalysts for the production of graphitic structures, carbon nanotubes, and the like. Reducing organic gases are one example of a feedstock for the synthesis of these materials.

When the coating is formed as a layer, it covers at least a portion of the surface area of the particles. In some cases, the layer may cover greater than 50%, greater than 75%, or substantially the entire (e.g., greater than 99%) surface area of the particles. The layer may have a thickness of less than 50 nm, less than 25 nm, or, in some cases, less than 10 nm. In some embodiments, the coating layer may have uniform thickness over a majority of the surface area of the particles. For example, the coating layer may have a thickness that varies less than 20% on greater than 50% of the surface area of the particles.

It should be understood that the particles, for example when formed of silicon, may have a native oxygen layer which may be in addition to any other coating that may be present. In some embodiments, it may be desirable to remove the native oxygen layer from the group IVA element. Techniques for removing the native oxygen layer are known in the art and can include treating the group IVA element with a chemical (e.g., hydrogen fluoride) and/or treating with heat. In some embodiments, the particles may not have a native oxide layer, for example when formed of germanium.

In some embodiments, the particle size of the milled particle composition is less than 500 nm. In certain embodiments, the average particle size may be even smaller. For example, the average particle size may be less than 250 nm, less than 150 nm, less than 100 nm, less than 75 nm, or less than 50 nm. In some embodiments, it may be preferred for the particle compositions to have very small particle sizes (e.g., an average particle size of less than 100 nm). In some cases, it is even possible to produce particle compositions having an average particle size of less than 30 nm, less than 20 nm, or less than 10 nm. Such particle sizes may be obtained, in part, by using grinding media having certain preferred characteristics, as described further below.

It should be understood that the particle sizes described herein may be for coated or uncoated group IVA particle compositions.

The preferred average particle size of the group IVA particle compositions typically depends on the intended application. In certain applications, it may be desired for the average particle size to be extremely small (e.g., less than 100 nm, less than 50 to nm, less than 25 nm, etc.); while, in other applications, it may be desired for the average particle size to be slightly larger (e.g., between 100 nm and 500 nm). In general, milling parameters may be controlled to provide a desired particle size, though in certain cases it may be preferable for the average particle size to be greater than 1 nm to facilitate milling. For example, the average particle size of the milled material may be controlled by a number of factors including grinding media characteristics (e.g., density, size, hardness, toughness), as well as milling conditions (e.g., specific energy input).

For purposes of this application, the “average particle size” of a particle composition is the numeric average of the “particle size” of a representative number of primary particles (non-agglomerated) in the composition. The “particle size” of a primary particle (non-agglomerated) is its maximum cross-sectional dimension taken along an x, y, or z-axis. For example, the maximum cross-sectional diameter of a substantially spherical particle is its diameter. For the values in the description and claims of this application, the particle sizes are determined using microscopy techniques, such as scanning electron microscope or transmission electron microscope techniques.

It should also be understood that particle compositions having average particle sizes outside the above-described ranges (e.g., greater than 500 nm) may be useful in certain embodiments of the invention.

In some embodiments, the particles have a minimum cross sectional dimension of less than 100 nm. That is, the smallest cross-sectional dimension is less than 100 nm. In some embodiments, the smallest cross-sectional dimension is less than 50 nm; 25 nm; less than 23 nm; or less than 10 nm.

The particle compositions may also be relatively free of large particles. That is, the particle compositions may include only a small concentration of larger particles. For example, the D₉₀ values for the compositions may be any of the above-described average particle sizes. Though, it should be understood that the invention is not limited to such D₉₀ values.

The particle compositions may also have a very high average surface area. The high surface area is, in part, due to the very small particle sizes noted above. The average surface area of the particle compositions may be greater than 1 m²/g; in other cases, greater than 5 m²/g; and, in other cases, greater than 50 m²/g. In some cases, the particles may have extremely high average surface areas of greater than 100 m²/g; or, even greater than 500 m²/g. It should be understood that these high average surface areas are even achievable in particles that are non-coated and/or substantially non-porous, though other particles may have surface pores. Surface area may be measured using conventional BET measurements. Such high surface areas may be obtained, in part, by using grinding media having certain preferred characteristics, as described further below.

Similar to particle size, the preferred average surface area of the particle composition typically depends on the intended application. In certain applications, it may be desired for the average surface area to be extremely large (e.g., greater than 50 m²/g, or greater than 260 m²/g); while, in other applications, it may be desired for the average surface area to be slightly smaller (e.g., between 50 m²/g and 1 m²/g). In general, milling parameters may be controlled to provide a desired surface area, though in certain cases it may be preferable for the average surface area to be less than 3,000 m²/g (e.g., for substantially non-porous particles). For example, the average surface area of the milled particle compositions may be controlled by a number of factors including grinding media characteristics (e.g., density, size, hardness, toughness), as well as milling conditions (e.g., energy, time).

As described further below, the milled particle compositions can be produced in a milling process. Thus, these particle compositions may be described as having a characteristic “milled” morphology/topology. Those of ordinary skill in the art can identify “milled particles”, which, for example, can include one or more of the following microscopic features: multiple sharp edges, faceted surfaces, and being free of smooth rounded “corners” such as those typically observed in chemically-precipitated particles. It should be understood that the milled particles described herein may have one or more of the above-described microscopic features, while having other shapes (e.g., platelet) when viewed at lower magnifications.

It should be understood that not all embodiments of the invention are limited to milled particles or milling processes.

In some embodiments, it may be preferable for the particles to have a platelet shape. For example, when the particles are formed of silicon, it may be preferable for the particles to have a platelet shape. In these cases, the particles may have a relatively uniform thickness across the length of the particle. The particles may have a substantially planar first surface and a substantially planar second surface with the thickness extending therebetween. The particle thickness may be smaller than the particle width and particle length. In some embodiments, the length and width may be to approximately equal; however, in other embodiments the length and width may be different. In cases where the length and width are different, the platelet particles may have a rectangular box shape. In certain cases, the particles may be characterized as having sharp edges. For example, the angle between a top surface (e.g., first planar surface) of the particle and a side surface of the particle may be between 75° and 105′; or between 85° and 95° degrees (e.g., about)90°. However, it should be understood that the particles may not have platelet shapes in all embodiments and that the invention is not limited in this regard. For example, the particles may have a substantially spherical or oblate spheroid shape, amongst others. It should be understood that within a milled particle composition, individual particles may be in the form of one or more of the above-described shapes.

In some embodiments, the compositions of the invention may comprise particles having a preferred crystallographic orientation. Suitable methods of forming the such particles have been described in commonly-owned, co-pending U.S. patent application Ser. No. 11/318,314, entitled “Small Particle Compositions and Associated Methods”, filed on Oct. 27, 2005, which is incorporated herein by reference. In some embodiments, a majority (i.e., greater than 50%) of the particles in a composition may have the same crystallographic orientation. In other embodiments, greater than 75% of the particles, or even greater than 95%, or even substantially all, of the particles in a composition may have the same crystallographic orientation.

The preferred crystallographic orientation of the particles may depend, in part, on the crystal structure of the material that forms the particles. In some embodiments, the group IVA-based particles may have a face-centered cubic structure that fractures along the 111 plane or 010 plane. Crystals generally preferentially fracture along specific planes with characteristic amounts of energy being required to induce fracture along such planes. During milling, such energy results from particle/grinding media collisions. It is observed that, by controlling the energy of such collisions via milling parameters (e.g., grinding media composition, specific energy input), it is possible to preferentially fracture particles along certain crystallographic planes which creates a particle composition having a preferred crystallographic orientation.

Crystallographic orientation of particles may be measured using known techniques. A suitable technique is x-ray diffraction (XRD). It may be possible to assess the relative percentage of particles having the same preferred crystallographic orientation using XRD.

An advantage of certain embodiments of the invention is that the particle sizes described herein can be achieved at very low contamination levels. The grinding media noted below may enable the low contamination levels when used with the above-described compositions because such characteristics lead to very low wear rates. For example, the milled compositions may have contamination levels may be less than 900 ppm, less than 500 ppm, less than 200 ppm, or even less than 100 ppm. In some processes, virtually no contamination may be detected which is generally representative of contamination levels of less than 10 ppm. As used herein, a “contaminant” is grinding media material introduced into the product material composition during milling. It should be understood that typical commercially available feed product materials may include a certain impurity concentration (prior to milling) and that such impurities are not includes in the definition of contaminant as used herein. Also, other sources of impurities introduced in to the product material, such as material from the milling equipment, are not included in the definition of contaminant as used herein. The “contamination level” refers to the weight concentration of the contaminant relative to the weight concentration of the milled material. Typical units for the contamination level are ppm. Standard techniques for measuring contamination levels are known to those of skill in the art including chemical composition analysis techniques.

In some embodiments, the particle compositions may be produced using a milling technique. In some processes, the milled particle sizes are achieved when the feed material particles (prior to milling) have an average particle size of greater than 1 micron, greater than 10 micron, or even greater than 50 micron. In some processes, the average particle size of the feed material particles may be greater than 10 times, 50 times, 100 times, or greater than 500 times the average particle size of the milled material. The specific particle size of the milled material depends on a number of factors including milling conditions (e.g., energy, time), though is also dictated, in part, by the application in which the milled material is to be used. In general, the milling conditions may be controlled to provide a desired final particle size. The particle size of the feed material may depend on commercial availability, amongst other factors.

The feed material may include particles and/or wafers, either of which may be single crystal. Milling of these feed materials can yield an end product that is amorphous and/or crystalline. In some embodiments, the feed material can be a doped wafer, which can be milled to produce doped small particles. In some cases, the feed material and the milled particles have the same crystallographic structure (e.g., amorphous, crystalline).

Particle compositions may be produced in a milling process that use grinding media as described herein. The processes may utilize a wide range of conventional mills having a variety of different designs and capacities. Suitable types of mills include, but are not limited to, ball mills, rod mills, attritor mills, stirred media mills, pebble mills and vibratory mills, among others. In some cases, the milling process may be used to de-agglomerate particles in the fluid carrier. In some cases, the milling process may also be used to produce coated particles as described herein.

Milling processes of the invention can involve the introduction of feed product material (e.g., feed particles) and a fluid carrier (creating a slurry) into a processing space in a mill in which the grinding media are confined. The viscosity of the slurry may be controlled, for example, by adding additives to the slurry such as dispersants. The mill is rotated at a desired speed and material particles mix with the grinding media. Collisions between the particles and the grinding media can reduce the size of the particles. The particles are typically exposed to the grinding media for a certain mill time after which the milled material is separated from the grinding media using conventional techniques, such as washing and filtering, screening or gravitation separation. The milling process may be performed at any temperature, including room temperature.

In some processes, the slurry of particles is introduced through a mill inlet and, after milling, recovered from a mill outlet. The process may be repeated and, a number of mills may be used sequentially with the outlet of one mill being fluidly connected to the inlet of the subsequent mill.

The milling process may be performed under ambient conditions (e.g., under exposure to air). The milling process may also be performed in the absence of air, for example, under a nitrogen atmosphere, argon atmosphere, or other suitable conditions.

As noted above, it may be preferred to use grinding media having specific characteristics. However, it should be understood that not every embodiment of the invention is limited in this regard. Suitable grinding media have been described, for example, in commonly-owned U.S. Pat. No. 7,140,567 which is incorporated herein by reference.

It should be understood that not all milling processes of the present invention use to grinding media having each of the above-described characteristics.

In some cases, conventional milling conditions (e.g., energy, time) may be used to process the particle compositions using the grinding media described herein. In other cases, the grinding media described herein may enable use of milling conditions that are significantly less burdensome (e.g., less energy, less time) than those of typical conventional milling processes, while achieving a superior milling performance (e.g., very small average particle sizes). In some cases, the stress energy may be greater than that of typical conventional milling processes.

The grinding media enable advantageous milling conditions. For example, lower milling times and specific energy inputs can be utilized because of the high milling efficiency of the grinding media of the invention. As used herein, the “specific energy input” is the milling energy consumed per weight product material. Even milled particle compositions having the above-noted particle sizes and contamination levels can be produced at low milling input energies and/or low milling times. For example, the specific energy input may be less than 125,000 kJ/kg; or less than 90,000 kJ/kg. In some cases, the specific energy input may be even lower such as less than 50,000 kJ/kg or less than 25,000 kJ/kg. The actual specific energy input and milling time depends strongly on the composition of the product material and the desired reduction in particle size, amongst other factors.

When the milled particles are coated, a variety of suitable techniques may be used. In some cases, the particles are coated by exposure to a gas or gas mixture. For example, the particles may be coated with carbon by exposing to a carbon source gas such as methane or other suitable organic gases. The exposure to the source gas may be at elevated temperatures such as greater than 500° C., e.g., between 600° C. and 800° C.

In other embodiments, a coating material precursor may be used. For example, a carbon coating material precursor may be used. In some cases, the coating material precursor may be carbonized and/or graphitized to form a suitable carbon coating. Techniques for achieving carbonization and/or graphitization, such as heating the carbon material precursor under inert atmosphere, are known to those skilled in the art. In other cases, the coating material precursor may be in the form of particles (e.g., small particles) that are smaller in size than the group IVA-based composition particles. The coating material precursor particles, for example carbon small particles, may be attached to surfaces of the group IVA-based composition particles to form a coating. The coating (e.g., coating material particles) may be attached to the group IVA-based composition particles via covalent or non-covalent interactions (e.g., hydrogen-bonding, ionic bonding, electrostatic interactions, van der Waals interactions, etc.).

The group IVA-based composition particles may be coated during a milling process. It may be preferred for the same milling process used to reduce the size of the group IVA-based composition particles also to be used to coat the particles. In these embodiments, particle size reduction is done in-situ with coating. In some cases, the size reduction and coating steps can occur consecutively; in other cases, size reduction and coating may occur at least somewhat (or entirely) simultaneously. In some embodiments, the milling process may also be used to de-agglomerate the group IVA-based composition particles and/or the coating material precursor particles (when present). In these embodiments, de-agglomeration can be done in-situ with particle size reduction and coating.

In some embodiments, a group IVA-based composition feed material including feed particles and a coating material precursor (e.g., coating material precursor particles) is suspended in a fluid carrier, and the suspension may be milled. As noted above, any suitable coating material precursor particle composition may be used, such as carbon black particles. In some cases, the fluid carrier is aqueous (e.g., water, or water-soluble fluids). In some cases, the fluid carrier is non-aqueous (e.g., an organic solvent). The feed material may be combined with a fluid carrier prior to and/or during milling. In some embodiments, the feed particles and coating material precursor may be milled in the absence of the fluid carrier to partially coat the particles, which may then be combined with the fluid carrier and milled

The particles may be further processed as desired for the intended application. For example, processing techniques may be used to incorporate the particles in components (e.g., electrodes) used in electrochemical cells (e.g., batteries). In some embodiments, the milled particles may be mixed with a fluid to facilitate further processing.

Suitable fluids include any fluid capable of forming a fluid mixture, solution, suspension, or dispersion with the group IVA particles. In some instances, the fluid may be selected such that the fluid does not undergo a chemical reaction with the group IVA particles. The fluid carrier may be aqueous or non-aqueous (e.g., organic). In some to cases, the fluid carrier is hydrophobic. In some cases, the fluid carrier is hydrophilic. Examples of fluid carriers may include neat water, aqueous solutions, hydrocarbons such as hexanes, aromatic hydrocarbons, ethers, and the like. In some cases, the solvent may be N-methylpyrrolidinone (NMP), N,N-dimethylformamide (DMF), dimethylsulfoxide (DMSO), isopropanol and the like.

The mixture may be a suspension of particles which also may include other conventional additives. Suitable additives include dispersants and/or surfactants which in some cases can facilitate dispersal of the group IVA-based composition may also be used. In some cases, binders are added to the mixture which, in some embodiments, can be useful in the formation of coating layers as described further below. Suitable binders include PVDF and PTFE. Advantageously, in certain embodiments, the mixture of particles and fluid may include little, or no, binder. Such mixtures with little or no binder surprisingly have been found to yield high quality coating layers. As described further below, such layers can have a very high percentage of active material (e.g., silicon) which can increase performance because the binder is present in little or no amounts.

The group IVA particles may be applied to a substrate by a variety of techniques. In some cases, a mixture of group IVA particles and a liquid is applied to a substrate. Suitable techniques for applying such mixtures include spin-coating, dip-coating, cast-coating, tape-coating, and the like. The coating may be applied to any suitable substrate. In some cases, the substrate is conductive. One example of a conductive substrate is copper.

In some embodiments, the coatings can be sintered. Sintering can be achieved, for example, by heating a coated substrate in a reducing atmosphere with organic gases such as methane. In some cases, temperatures between about 500° C. and about 1000° C. are suitable for sintering. Temperatures outside this range may also be used. Sintering may also be achieved by laser annealing. Other sintering techniques will be known to those skilled in the art.

In other embodiments, the coatings may be annealed to the substrate. In some cases, improved adhesion of the group IVA small particles to the substrate may be realized through an annealing process. Typically, annealing can be conducted between about 600° C. and about 700° C. Other temperatures may be used as well.

The thickness of the coating layer can, in some instances, be adjusted varying the viscosity of the slurry used to coat the substrate and other parameters. For example, varying the speed and duration of a spin-coating operation can control the thickness of a coating. In the case of dip-coating, the rate at which a substrate is removed from the slurry may influence the thickness of the coating. The thickness of the coating can, in some cases, be less than about 500 microns, less than about 100 microns, less than about 50 microns, less than about 10 microns. The specific thickness will depend on the application.

As noted above, one advantage of certain embodiments is the ability to coat a substrate to form a layer having a high percentage of active material (e.g., the group IVA material such as silicon). In this context, the active material is a material that is actively involved in the performance of the layer during use. In some embodiments, the percentage of active material by weight may be greater than about 50%, greater than about 75%, greater than about 90%, or greater than about 95% such as 100%. In some cases, the layers may be free of any binder. Such high percentages lead to excellent performance, for example, as electrode materials in battery applications or conductive materials in electronic applications.

One advantage of the coating layers formed from the particle compositions disclosed herein is the ability of such layers to absorb stress during use. For example, the layers may absorb stress related to the expansion and/or contraction of an electrode during use. In lithium batteries the electrode can experience significant expansion and/or contraction during lithiation and delithiation. Such changes in the electrode can, in some cases, cause a coating layer on the electrode to crack or delaminate. The coatings disclosed herein have superior stress absorption properties, which allow the coatings to tolerate such volumetric changes in the electrode. Several factors may contribute to the ability of the coating layers to absorb stress including the particle size, the fact that portions of the individual particles within the coating may have an amorphous structure in the expandable state and these portions may adopt a crystalline structure upon lithiation, and the presence of a coating (e.g., carbon) on the particles. However, it should be understood that layers may still exhibit advantageous stress absorption properties when formed of particles that are not coated.

Particles which are processed using methods described herein may have many advantages. The small particle sizes may lead to improved electrochemical performance (e.g., for batteries) such as increased charging/discharging rates, increased capacity, increased power density, increased cost savings, and increased operational lifetime (e.g., the number of charging/discharging cycles without degeneration). Milling processes of the invention may be simple and efficient and may eliminate the need for additional processing steps, when compared to known methods. In some cases, the feed particles may be milled and coated in one milling step. In some cases, the desired particle composition (including desired particle sizes) may be obtained without need for additional processing steps, such as spray-drying, re-firing, etc.

As noted above, the particle compositions may be used in a number of applications including electrochemical applications. Suitable electrochemical applications include batteries. In some cases, the group IVA composition may be an anode. For example, the anode may be silicon-based.

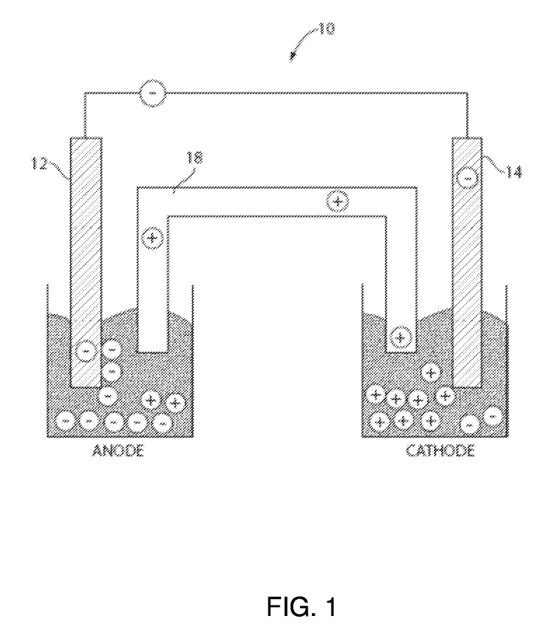

FIG. 1 schematically illustrates an electrochemical cell 10 according to one embodiment of the invention. The electrochemical cell includes an anode 12 (i.e., negative electrode) connected to a cathode 14 (i.e., positive electrode) via an external circuit. The anode and/or cathode may comprise the group IVA particle compositions described herein. An oxidation reaction occurs at the anode where electrons are lost and a reduction reaction occurs at the cathode where electrons are gained. An electrolyte 18 allows positive ions to flow from the anode to the cathode, while electrons flow through the external circuit which can function as a power source. A separator may electrically isolate the anode and the cathode, amongst other functions.

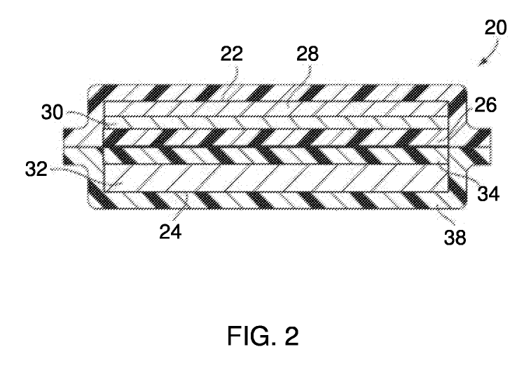

FIG. 2 schematically illustrates a battery cell structure 20 according to another embodiment of the invention. The battery cell structure includes an anode side 22, a cathode side 24 and an electrolyte/separator 26 positioned therebetween. The anode side includes a current collector 28 (e.g. formed of copper open mesh grid) formed on an active material layer 30. The cathode side includes a current collector 32 (e.g., formed of an aluminum open mesh grid) and an active material layer 34. A protective cover 38 may surround the battery cell structure.

Any suitable electrolyte/separator may be used. For example, the electrolyte/separator may be a solid electrolyte or separator and liquid electrolyte. Solid electrolytes can include polymer matrixes. Liquid electrolytes can comprise a solvent and an alkaline metal salt, which form an ionically conducting liquid. It should be understood that electrochemical cells (e.g., batteries) of the invention may have a variety of different structures constructions and the invention is not limited in this regard.

It should be understood that the particle compositions may be used in a variety of other applications. In some cases, the particle compositions may be used as electronic inks For example, the inks (e.g. Si and/or Ge) may be used in thin-film transistor (TFT) applications and in photovoltaic cells.

The following examples are provided for illustration purposes and are not intended to be limiting.

### EXAMPLES

### Example 1

This example demonstrates the preparation of a silicon small particle slurry.

In a 500 mL flat bottom beaker, 70 g silicon having average an average dimension of 50-60 nm were added with stirring to 370 g 99.9% IPA containing a mixture of conventional dispersants to create a dispersion with 15.9% w/w solids loading.

The slurry mixture was transferred into a 500 mL open tank and stirred with a CAT R-18 mixer. A Masterflex console peristaltic pump was used at a speed setting of 4 to transfer the slurry into a Netzsch MiniCer with an agitation speed of 1200 RPM for 34 minutes using 1.7-1.9 mm YTZ in order to disperse the Si in IPA.

The resulting slurry yielded a final w/w percent solids of 12.10% as determined by drying in a Mettler Toledo HR83-P Moisture Analyzer.

In a 500 mL flat bottom beaker, the processed mixture of 55 g silicon was transferred into a 500 mL open tank and stirred with a CAT R-18 mixer. A Masterflex console peristaltic pump was used at a speed setting of 4 to transfer the slurry into the Netzsch MiniPur with an agitation speed of 1200 RPM for 238 minutes using grinding media. The total energy input measured in kilojoules per kilogram of starting solids was equal to 140000 kJ/kg. The resulting slurry yielded a final w/w percent solids of 12.18% as determined by drying in a Mettler Toledo HR83-P Moisture Analyzer. The particle size was about 50 nm, as determined by a Dispersion Technology DT1200, and the BET surface area was 67 m²/g.

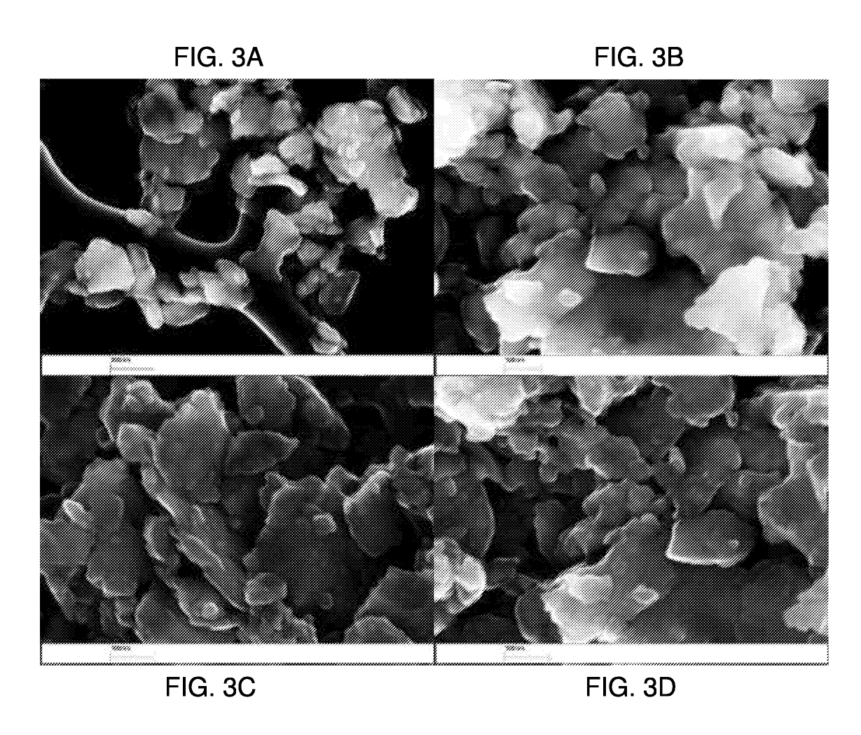

The final slurry weight after pre-processing was 454 g at 12.10% w/w solids, which equaled 55 g of solids weight. This weight is used for the processing formulation. XRD analysis confirmed the silicon was phase pure. FIGS. 3A-3D show copies of SEM images of the silicon small particles.

### Example 2

This example demonstrates dip-coating of a copper foil using the silicon small particle dispersion.

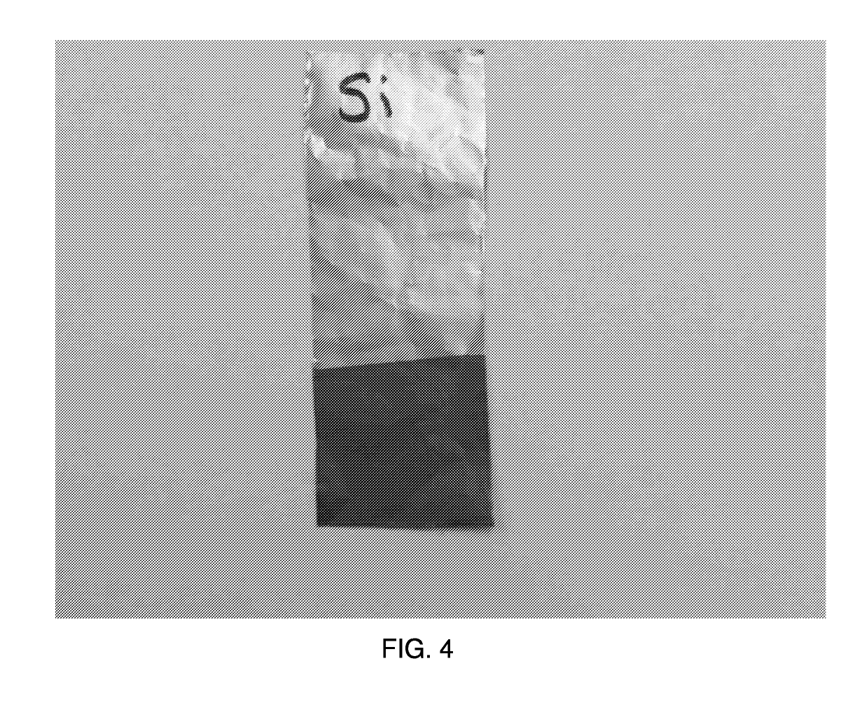

The dispersion in Example 1 was dip-coated directly on a copper foil and annealed at elevated temperature using an inert or reducing atmosphere. FIG. 4 shows a copy of a photograph depicting a dip-coated copper foil.

### Example 3

This example demonstrates spin-coating of a copper foil using the silicon small particle dispersion.

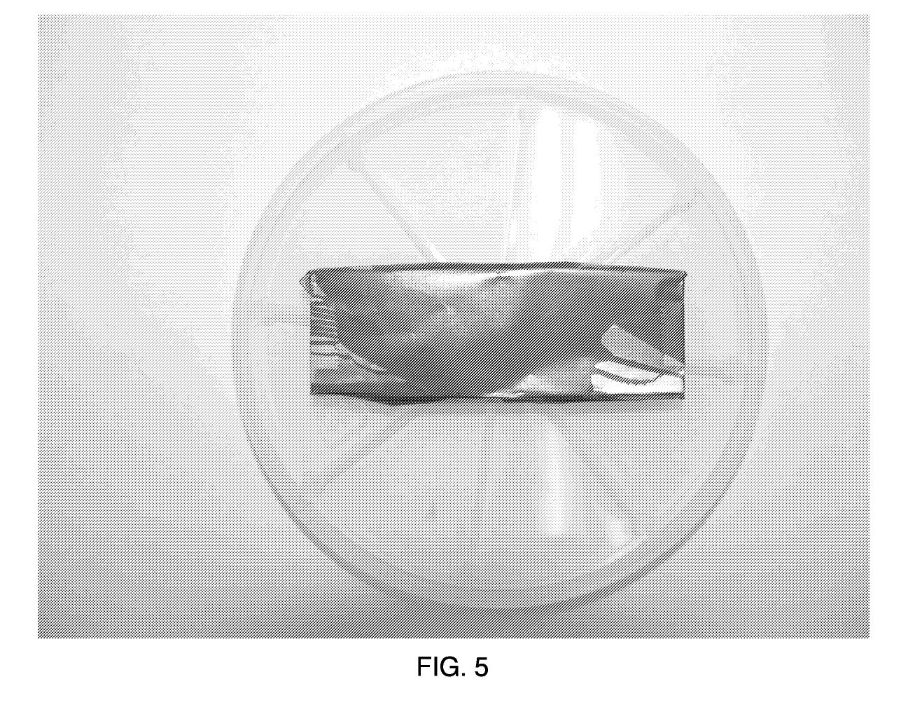

A copper foil was cleaned with isopropanol, and the dispersion in Example 1 was spin-coated directly on the copper foil using a conventional spin-coating apparatus. The spin-coating was conducted at 800 RPM for about 30 seconds. FIG. 5 shows a copy of a photograph exemplifying a spin-coated copper foil.

### Example 4

This example demonstrates the application of a carbon coating on the small particles in the dispersion.

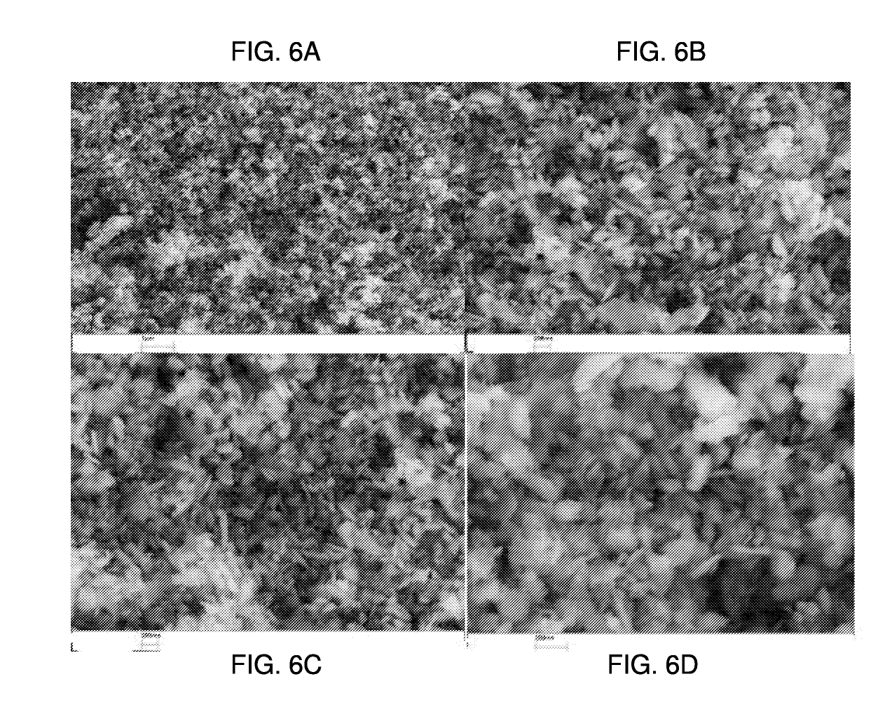

The dispersion from Example 1 was mixed with a solution of cellulose acetate in isopropanol to coat the particles with cellulose acetate, dried, and fired in a tube furnace at 700° C. under inert or reducing conditions to generate a graphite coating. EDX established that the carbon coating was graphite. FIGS. 6A-6D show copies of SEM images of the carbon-coated silicon small particles.

### Example 5

This example demonstrates the preparation of a Sn-based intermetallic small particle slurry.

In a 500 mL flat bottom beaker, 90 g of CoCu₅Sn₅ having a size of about 20 microns to about 100 microns were added with stirring to 400 g 99.9% IPA containing a mixture of surfactants. The slurry mixture was transferred into a 500 mL open tank and stirred with a CAT R-18 mixer. A Masterflex console peristaltic pump was used at a speed setting of 4 to transfer the slurry into a Netzsch MiniCer with an agitation speed of 1200 RPM for 34 minutes using 2 mm YTZ in order to disperse the intermetallic particles in IPA.

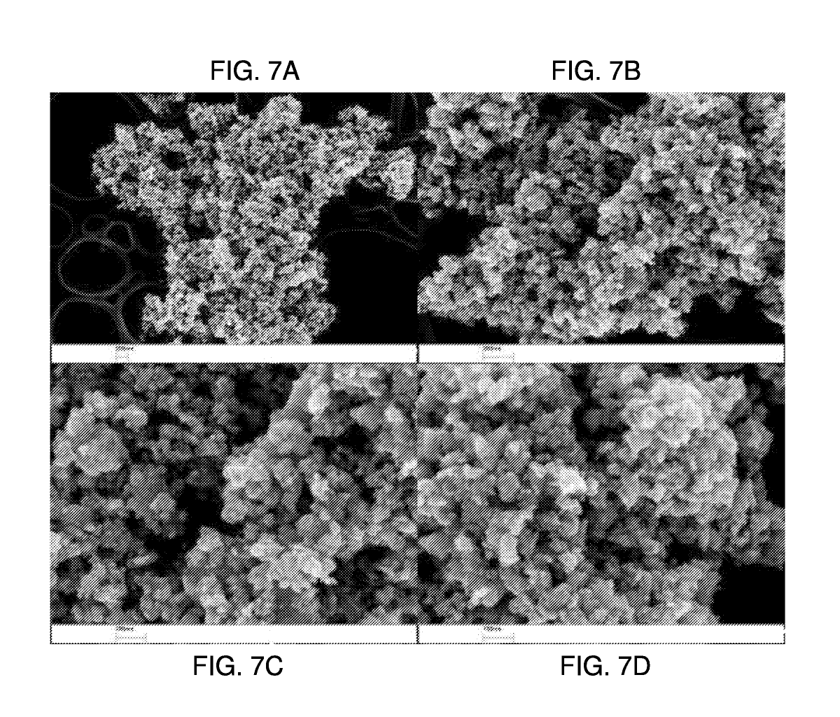

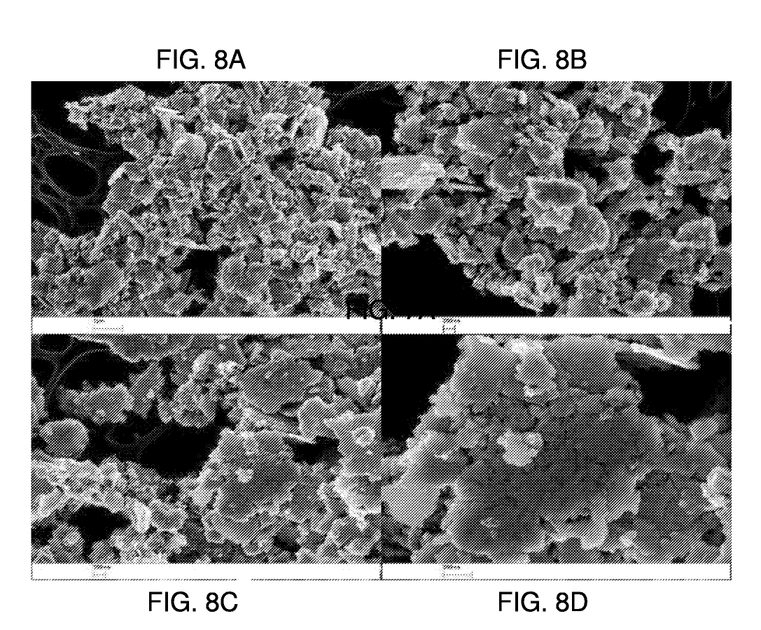

In a 500 mL flat bottom beaker, the processed mixture of the intermetallic was transferred into a 500 mL open tank and stirred with a CAT R-18 mixer. A Masterflex console peristaltic pump was used at a speed setting of 4 to transfer the slurry into the Netzsch MiniPur with an agitation speed of 1200 RPM for 238 minutes using grinding media. The resulting slurry yielded a final w/w percent solids of 11.07% as determined by drying in a Mettler Toledo HR83-P Moisture Analyzer. When the total energy input measured in kilojoules per kilogram of starting solids was equal to 150000 kJ/kg, the particle size was 30 nm, as determined by SEM (FIGS. 7A-7D, which show copies of SEM images of the Sn-based particles). When the total energy input measured was equal to 20000 kJ/kg, the particle size was 200 nm, as determined by SEM (FIGS. 8A-8D, which show copies of SEM images of the Sn-based small particles).

### Example 6

This example demonstrates the application of a carbon coating on the Sn-based small particles in the dispersion.

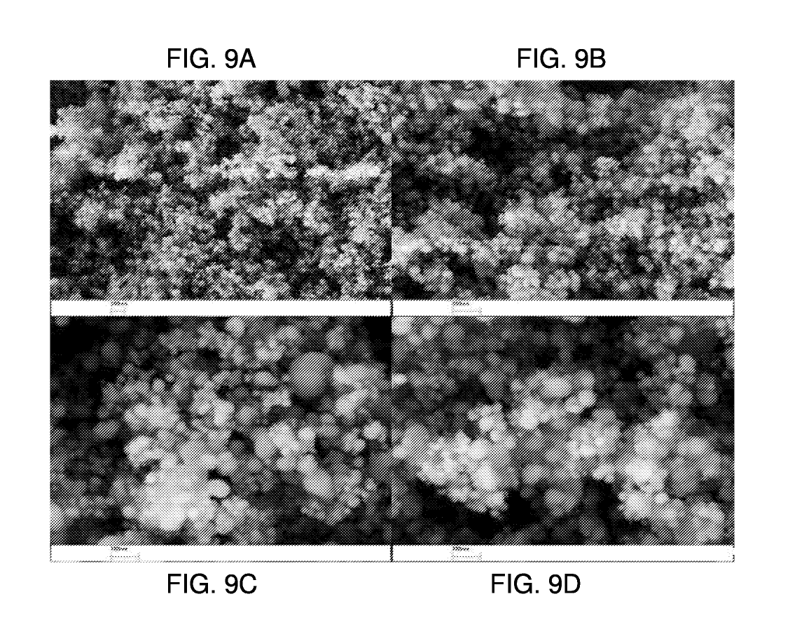

The dispersed particles in example 6 were mixed with a solution of cellulose acetate in isopropanol and then treated in a furnace at 500° C. in forming gas. This was done to achieve a carbon coating. FIGS. 9A-9D show copies of SEM images of the carbon-coated Sn-based small particles.

### Example 7

This example demonstrates the preparation of an arsenic-doped germanium small particle slurry.

Arsenic doped germanium wafers were crushed to about 100 microns and dispersed by using appropriate commercial dispersants, and 51 g of crushed Ge doped wafer was dispersed in anhydrous IPA using 2 mm YTZ media. In a 500 mL flat bottom beaker, the processed mixture of doped Ge was transferred into a 500 mL open tank and stirred with a CAT R-18 mixer. A Masterflex console peristaltic pump was used at a speed setting of 4 to transfer the slurry into the Netzsch MiniPur with an agitation speed of 2400 RPM for 133 minutes using grinding media. The total energy input measured in kilojoules per kilogram of starting solids was equal to 110000 kJ/kg.

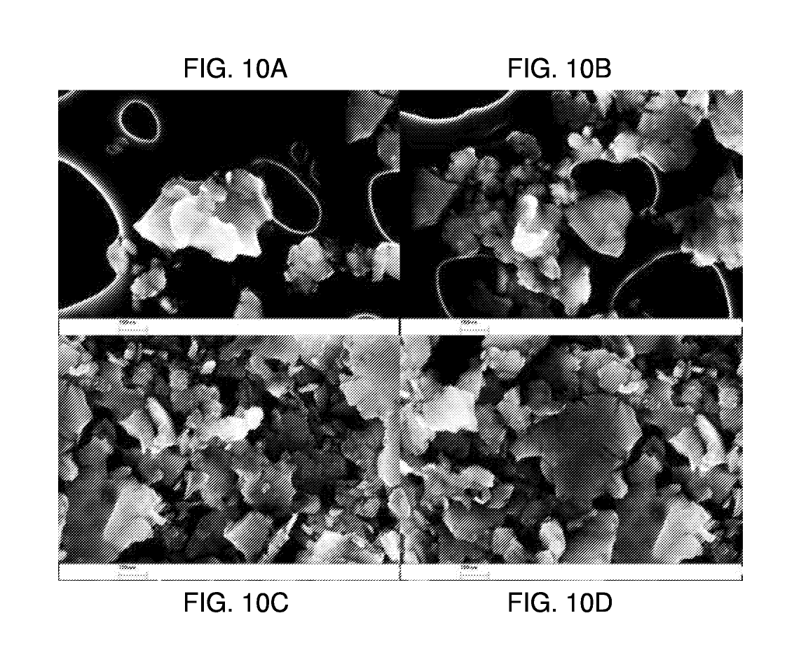

The resulting slurry yielded a final w/w percent solids of 11% as determined by drying in a Mettler Toledo HR83-P Moisture Analyzer. The particle size was about 40 nm, as determined by DT1200 (FIGS. 10A-10D show copies of SEM images of the arsenic-doped germanium small particles).

### Example 8

This example demonstrates the preparation of a silicon and germanium small particle slurry mixture.

In a 500 mL flat bottom beaker, 25 g germanium and 25 g silicon were stirred in 300 g anhydrous IPA to create a dispersion having 14.3% w/w solids. The slurry mixture was transferred into a 500 mL open tank and stirred with a CAT R-18 mixer. A Masterflex console peristaltic pump was used at a speed setting of 4 to transfer the slurry into the Netzsch MiniPur with an agitation speed of 2400 RPM for 25 minutes using 1.7-1.9 mm YTZ media. This was done for dispersion purposes.

The resulting slurry yielded a final percent solids of 9.78% as determined by drying in a Mettler Toledo HR83-P Moisture Analyzer.

The final slurry weight after dispersion was 360 g at 9.78% solids, which equaled 36 g of solids weight. This weight is used for the processing formulation.

In a 500 mL flat bottom beaker, the pre-processed mixture of 25 g germanium and 25 g silicon was transferred into a 500 mL open tank and stirred with a CAT R-18 mixer. A Masterflex console peristaltic pump was used at a speed setting of 4 to transfer the slurry into the Netzsch MiniPur with an agitation speed of 2400 RPM for 120 minutes using grinding media. The total energy input measured in kilojoules per kilogram of starting solids was equal to 100,000 kJ/kg.

The resulting slurry yielded a final w/w percent solids of 9.77% as determined by drying in a Mettler Toledo HR83-P Moisture Analyzer. The XRD of the final product was an intimately mixed Si/Ge sample.

### Example 9

This example demonstrates the preparation of a graphite slurry.

In a 500 mL flat bottom beaker, 30 g graphite were dispersed in 270 g distilled water for 10% solids loading.

The slurry mixture was transferred into a 500 mL open tank and stirred with a CAT R-18 mixer. A Masterflex console peristaltic pump was used at a speed setting of 4 to transfer the slurry into the Netzsch MiniCer with an agitation speed of 2400 RPM for 19 minutes using 2 mm YTZ media. This was done for dispersion purposes. The resulting slurry yielded a final w/w percent solids of 7.99% as determined by drying in a Mettler Toledo HR83-P Moisture Analyzer.

The final slurry weight after pre-processing was 288 g at 7.99% solids, which equaled 23 g of solids weight. This weight is used for the processing formulation.

In a 500 mL flat bottom beaker, the pre-processed mixture of 23 g graphite was transferred into a 500 mL open tank and stirred with a CAT R-18 mixer. A Masterflex console peristaltic pump was used at a speed setting of 4 to transfer the slurry into the Netzsch MiniPur with an agitation speed of 2400 RPM for 19 minutes using grinding media. The total energy input measured in kilojoules per kilogram of starting solids was equal to 30000 kJ/kg.

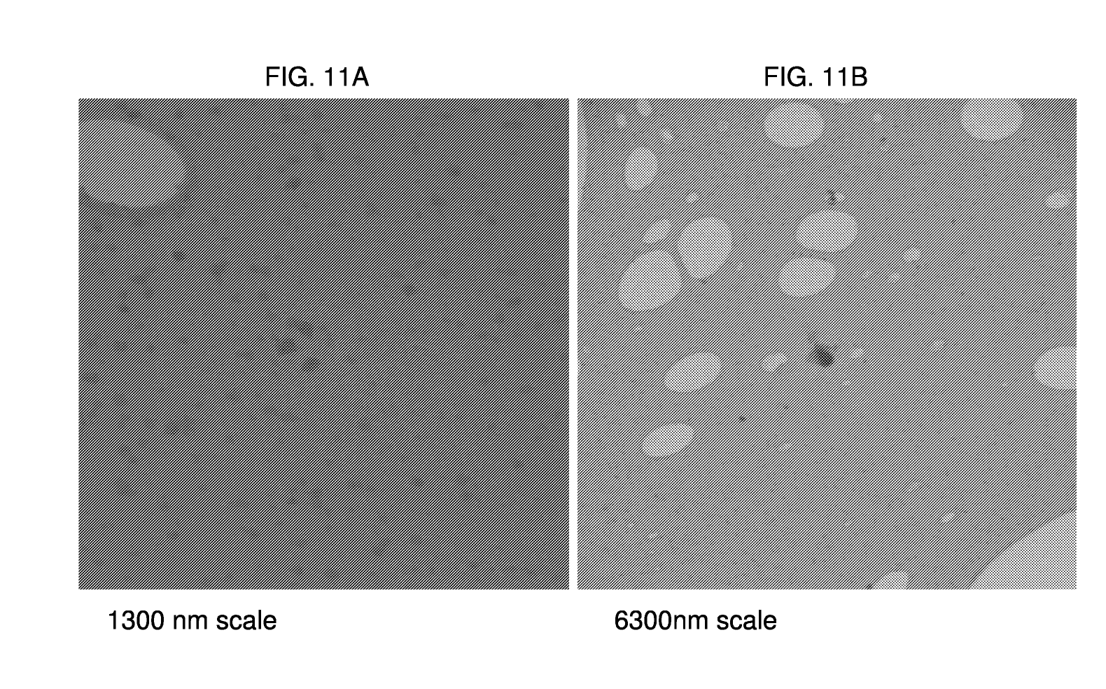

The resulting slurry yielded a final w/w percent solids of 5.28% as determined by drying in a Mettler Toledo HR83-P Moisture Analyzer. The particle size was about 20 nm, as determined by TEM, and Raman spectroscopy indicated the presence of the graphite G and D band. FIGS. 11A and 11B show copies of STEM images of the graphite small particles.

### Example 10

This example demonstrates the preparation of a silicon and graphite small particle slurry mixture.

In a 500 mL flat bottom beaker, 50 g silicon and 50 g carbon were dispersed in NMP with manual stirring for approximately 3 minutes in 400 g NMP to yield a 20% solids loading.

The slurry mixture was transferred into a 500 mL open tank and stirred with a CAT R-18 mixer. A Masterflex console peristaltic pump was used at a speed setting of 4 to transfer the slurry into the Netzsch MiniCer with an agitation speed of 2400 RPM for 87 minutes using 2 mm YTZ media.

The resulting slurry yielded a final w/w percent solids of 18.55% as determined by drying in a convection oven.

The final slurry weight after pre-processing was 532 g at 18.55% solids, which equaled 99 g of solids weight. This weight is used for the processing formulation.

In a 500 mL flat bottom beaker, the pre-processed mixture of 99 g silicon and graphite was transferred into a 500 mL open tank and stirred with a CAT R-18 mixer. A Masterflex console peristaltic pump was used at a speed setting of 4 to transfer the slurry into the Netzsch MiniPur with an agitation speed of 2400 RPM for 96 minutes using grinding media. The total energy input measured in kilojoules per kilogram of starting solids was equal to 45000 kJ/kg.

The resulting slurry yielded a final percent solids of 7.45% as determined by drying in a Convection Oven.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method, comprising:
milling a feed material to form particles comprising a group IVA element and having an average particle size of less than 250 nm; and
contacting a substrate with a mixture of the particles and a liquid to form a layer comprising the group IVA element on the substrate.

2. The method of claim 1, wherein the group IVA element is Si.

3. The method of claim 1, wherein the group IVA element is Ge.

4. The method of claim 1, wherein the step of contacting comprises dip-coating the substrate into the mixture to form the layer.

5. The method of claim 1, wherein the step of contacting comprises spin-coating the mixture on to the substrate to form the layer.

6. The method of claim 1, wherein the particles have an average particle size of less than 100 nm.

7. The method of claim 1, wherein the particles have an average particle size of less than 50 nm.

8. The method of claim 1, further comprising coating the particles prior to the contacting step.

9. The method of claim 8, wherein the coating is a conductive coating.

10. The method of claim 9, wherein the coating is carbon.

11. The method of claim 10, wherein the coating comprises at least some carbon with an sp2 configuration.

12. The method of claim 1, wherein the layer comprises greater than about 90% by weight of the particles.

13. A method, comprising:
milling a feed material to form particles comprising a group IVA element; and
forming a carbon coating on the particles having a thickness of less than 50 nm.

14-21. (canceled)

22. A method, comprising:
providing a mixture of particles comprising the group IVA element and a liquid;
contacting a substrate with the mixture to form a layer on the substrate, the layer comprising greater than 50% by weight of the group IVA element.

23-25. (canceled)

26. A particle composition, comprising:
particles comprising a group IVA element and having an average particle size of less than 100 nm,
wherein the particle composition is spin-coatable.

27. The composition of claim 26, wherein the group IVA element is Si.

28. The composition of claim 26, wherein the group IVA element is Ge.

29. The composition of claim 26, wherein the average particle size is less than 50 nm.

30. The composition of claim 26, wherein the particles have a platelet shape.

31. A particle composition, comprising:
particles comprising a group IVA element and having an average particle size of less than 100 nm, the particles having a carbon coating.

32-38. (canceled)
